(19) United States
(12) Patent Application Publication
(10) Pub. No.: US 2012/0265904 A1
(43) Pub. Date: Oct. 18, 2012

(54) PROCESSOR SYSTEM

(75) Inventor: Hideki MATSUYAMA, Kanagawa (JP)

(73) Assignee: Renesas Electronics Corporation

(21) Appl. No.: 13/527,200

(22) Filed: Jun. 19, 2012

Related U.S. Application Data
(63) Continuation of application No. 12/760,152, filed on Apr. 14, 2010, now Pat. No. 8,222,109.

(30) Foreign Application Priority Data
Jun. 23, 2011 (JP) 2011-139582

(51) Int. Cl. G06F 13/14

(52) U.S. Cl. 710/5

(57) ABSTRACT

Disclosed herein is a processor system including a specific code area setting register holding a first set value corresponding to an address range of a specific code area in which a specific program is stored; a peripheral device having a specific data storage area for storing specific data to be used by the specific program; a processor element outputting an access request to the peripheral device upon executing programs including the specific program, and determining whether the program executed by reference to the first set value is the specific program, and a safety guard controlling access to the specific data storage area depending on whether the access request results from the execution of the specific program.

### CROSS-REFERENCE TO RELATED APPLICATIONS

The disclosure of Japanese Patent Application No. 2011-139582 filed on Jun. 23, 2011 including the specification, drawings and abstract is incorporated herein by reference in its entirety.

### BACKGROUND

The present invention relates to a processor system. More particularly, the invention relates to a processor system configured in such a manner that when multiple programs are operated, the system prevents the data to be used by one program from getting altered unintentionally by any other program.

In recent years, there have been numerous cases in which multiple programs are run on a single processor system. Where the programs are performed on one processor system, a given program may run into a program if the data it uses is altered unintentionally by some other program.

Japanese Unexamined Patent Publication No. 2007-11639 (Patent Literature 1) discloses an example in which, of the processes performed by a processor system, those required to be highly reliable are processed by multiple processors and the results of the processing are compared with one another to enhance process reliability. However, the technique disclosed in Patent Literature 1 is not designed to prevent alteration of data between the programs run on the processor system and is incapable of forestalling the problem of data alteration.

Japanese Unexamined Patent Publication No. 2008-123031 (Patent Literature 2) discloses an example in which the data used by one program is prevented from getting altered unintentionally by some other program where multiple programs are run on one processor system. Patent Literature 2 describes a multi-processor system having four CPUs (central processing units) as a typical processor system. The multi-processor system disclosed in Patent Literature 2 includes an access authority information holding means for holding information about the access authority of each processor with regard to multiple memory areas, and a memory managing means for managing access of each processor to the memory based on the access authority information. That is, the processor system described in Patent Literature 2 controls the processors in such a manner that they can access appropriate memory areas in accordance with the information about the access authorities of the processors.

### SUMMARY

However, according to the processor system of Patent Literature 2, the set values defining a given processor allowed to access a certain memory area can be altered by any other processor (or program). That is, if the set values defining one processor authorized to access a given memory area are altered unintentionally, then the processor system of Patent Literature 2 is incapable of protecting the data held in that memory area from getting altered unintentionally by some other processor (or program).

According to one aspect of the present invention, there is provided a processor system including a specific code area setting register configured to hold a first set value corresponding to an address range of a specific code area in which a specific program is stored; a peripheral device configured to have a specific data storage area for storing specific data to be used by the specific program; a processor element configured to output an access request to the peripheral device upon executing programs including the specific program, and to determine whether the program executed by reference to the first set value is the specific program, and a safety guard configured such that if the access request results from the execution of the specific program, the safety guard permits access to the specific data storage area and that if the access request results from the execution of a program other than the specific program, then the safety guard invalidates access to the specific data storage area.

According to another aspect of the present invention, in the processor system, a specific program that accesses the specific data targeted to be protected is stored in a specific code area of which the address range is predetermined. Also, the processor system of the present invention determines whether the program being executed is the specific program based on an address of a programmable area where the executed program was stored. If any program other than the specific program unintentionally issues an access request for the specific data, the safety guard of the processor system acts to invalidate the access request. In this manner, the inventive processor system prevents the specific data from getting altered unintentionally by any program other than the specific program.

According to the aspects of the processor system, the system thus protects specific data from getting altered by an unintended program.

### BRIEF DESCRIPTION OF THE DRAWINGS

Further objects and advantages of the present invention will become apparent upon a reading of the following description and appended drawings in which:

FIG. 1 is a block diagram outlining a processor system according to the present invention;

FIG. 2 is a block diagram showing a processor system as a first embodiment of the present invention;

FIG. 3 is a block diagram showing a safety guard of the processor system as the first embodiment;

FIG. 4 is a schematic view of a memory space map showing a specific code area and a specific data area of the first embodiment;

FIG. 5 is a block diagram showing a processor system as a second embodiment of the present invention;

FIG. 6 is a block diagram showing a safety guard of the processor system as the second embodiment;

FIG. 7 is a schematic view of a memory space map showing a specific code area and a specific data area of the processor system as the second embodiment;

FIG. 8 is a schematic view of a detailed memory space map unique to a first processor element of the processor system as the second embodiment;

FIG. 9 is a schematic view of a detailed memory space map unique to a second processor element of the processor system as the second embodiment;

FIG. 10 is a schematic view of a detailed memory space map unique to a third processor element of the processor system as the second embodiment;

FIG. 11 is a block diagram of a processor system as a third embodiment of the present invention;

FIG. 12 is a block diagram of a processor system as a fourth embodiment of the present invention; and

FIG. 13 is a flowchart showing how a system controller of the processor system as the fourth embodiment operates.

### DETAILED DESCRIPTION

### First Embodiment

Some preferred embodiments of the present invention will now be described below with reference to the accompanying drawings. Before going into a detailed explanation of the embodiments, the following paragraphs will outline the processor system to which the present invention is applied. Although this invention is shown applied to the processor system to be discussed below, that system is only an example; the invention can also be applied to other processor systems.

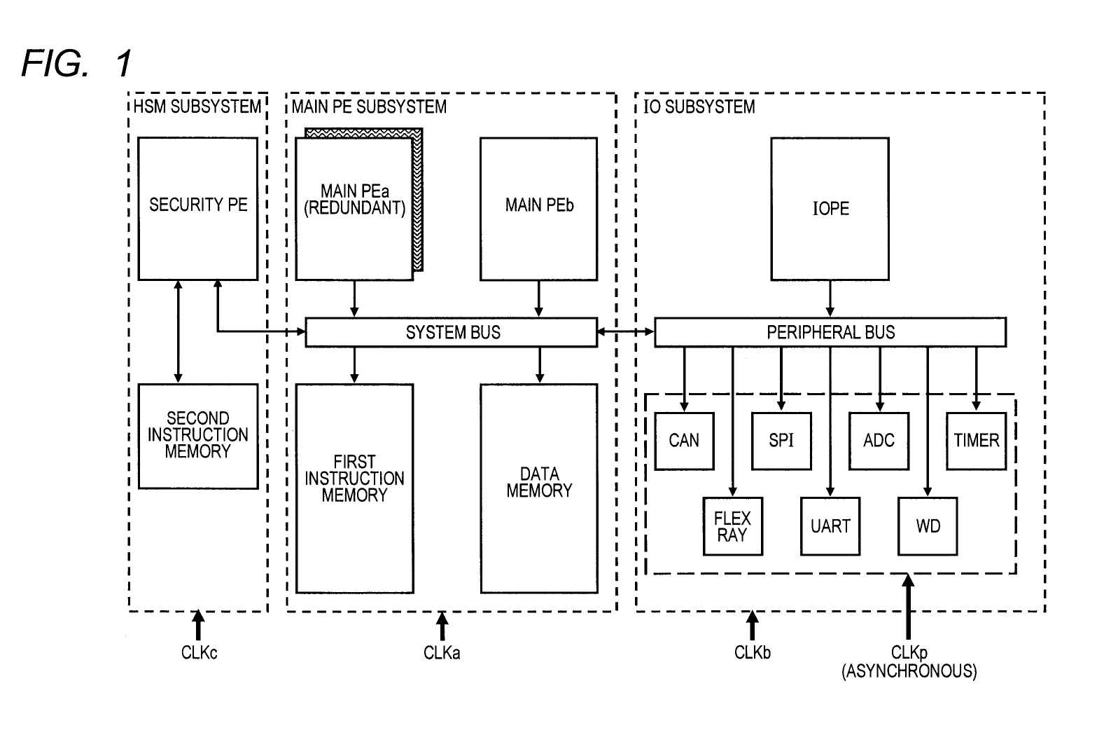

FIG. 1 is a block diagram outlining the processor system to which the present invention is applied. As shown in FIG. 1, the processor system of the present invention is designed to improve performance by utilizing multiple PEs (processor elements). Also, the inventive processor system categories its functions into three subsystems apart from the classification of its functional blocks based on the PEs. As shown in FIG. 1, the processor system of the present invention has a main PE (processing element) subsystem, an IO (input output) subsystem, and an HSM (hardware security module) subsystem.

The main PE subsystem performs specific processes required of the processor system based on preinstalled programs or on the programs read from the outside. The IO subsystem performs various processes for peripheral devices used by the main PE subsystem or by the HSM subsystem to function. The HMS subsystem performs security checks on the processes being carried out by the processor system. Also, the processor system of the present invention provides the subsystems with clock signals CLKa, CLKb, CLKc and CLKp. In the example shown in FIG. 1, the clock signal CLKa is fed to the main PE subsystem, the clock signals CLKb and CLKb are supplied to the IO subsystem, and the clock signal CLKc is provided to the HSM subsystem. The clock signals CLKa, CLKb, CLKc and CLKp may be assigned the same or a different frequency each depending on the specifications of the overall system configuration. The clock signal CLKp is fed to the peripheral devices and is asynchronous with the clock signal CLKb supplied to the IO subsystem.

This and the ensuing paragraphs will explain each subsystem in more detail. The main PE subsystem has a main PEa, a main PEb, a first instruction memory, a data memory, and a system bus. In the main PE subsystem, the main PEa, main PEb, instruction memory, and data memory are coupled with one another via the system bus. The first instruction memory stores programs. The data memory temporarily stores the programs read from the outside as well as the data having been processed inside the processor system. Each of the main PEa and main PEb performs programs using the instruction memory, data memory, and other resources. The main PEa is configured to operate in a redundant manner. Operating redundantly means that in software terms, the main PEa works as a single processor element and that in hardware terms, the main PEa is configured in multiplexed fashion or supplemented with check circuits or the like so as to operate reliably. A typical redundant operation is a lock-step operation that determines whether the results output from multiple circuits on each clock cycle coincide with one another.

The IO subsystem has a peripheral bus, an IOPE, and peripheral devices. The IOPE performs processes needed for the peripheral devices to be used. The IOPE may operate based on the programs stored in the first instruction memory of the main EP system or on the programs held in other storage areas. The peripheral bus couples the IOPE with the peripheral devices.

In FIG. 1, a CAN unit, a FLEX RAY unit, an SPI unit, a UART unit, an ADC unit, a WD unit, and a timer are shown as typical peripheral devices. The CAN unit performs communication based on CAN (Controller Area Network), an in-vehicle communication standard. The FLEX RAY unit performs communication based on the Flex Ray standard, another in-vehicle communication standard. The SPI unit performs communication based on SPI (System Packet Interface), a three- or four-wire serial communication standard. The UART (Universal Asynchronous Receiver Transmitter) unit converts asynchronous serial signals to parallel signals and vice versa. The ADC (Analog to Digital Converter) unit converts analog signals fed from sensors or the like to digital signals. The WD (Watch Dog) unit provides a watchdog timer function for detecting that a predetermined time period has elapsed. The timer measures time and generates waveforms, among others. Although the above-mentioned units are shown to be the peripheral devices in the example of FIG. 1, this is not limitative of the present invention. Units offering other functions may also be included. Alternatively, only some of these units may be included.

The HSM subsystem has a security PE and a second instruction memory. The security PE is coupled to the system bus. The security PE determines the validity of the program being executed by the main PE subsystem or that of the data obtained through program execution. The second instruction memory stores programs. The second instruction memory may be accessed solely by the security PE. Whereas the second instruction memory may be provided as part of a single storage area that also includes the first instruction memory, the second instruction memory needs to be controlled as the area that can only be accessed by the security PE.

As discussed above, the processor system to which the present invention is applied provides high resistance to such irregularities as unexpected failures and unintended program alterations while improving performance using multiple PEs. The above-described processor system is only an example of processor system to which the invention is applied. In another example, the configuration of the instruction memory and data memory and their numbers in the system may be varied depending on the architecture of the system. In yet another example, the memories may be coupled with the processor elements via multiple buses or without the intervention of buses. The processor system may thus be diversely configured depending on architecture design.

The foregoing explanation of the processor system was intended to depict an overall configuration of the processor system to which the present invention is applied. In the ensuing description of the invention, other parts or components not mentioned in the foregoing explanation will be added and explained as needed.

The processor system discussed above includes the main PEa, main PEb, security PE, and IOPE. The features of the present invention are applicable to any one or all of these processor elements. Thus in the description that follows, the main PEa, main PEb, security PE, and IOPE will be generically referred to as the processor element PE. The first embodiment of the present invention is explained below as a processor system that has one processor element so as to better clarify the features of the invention.

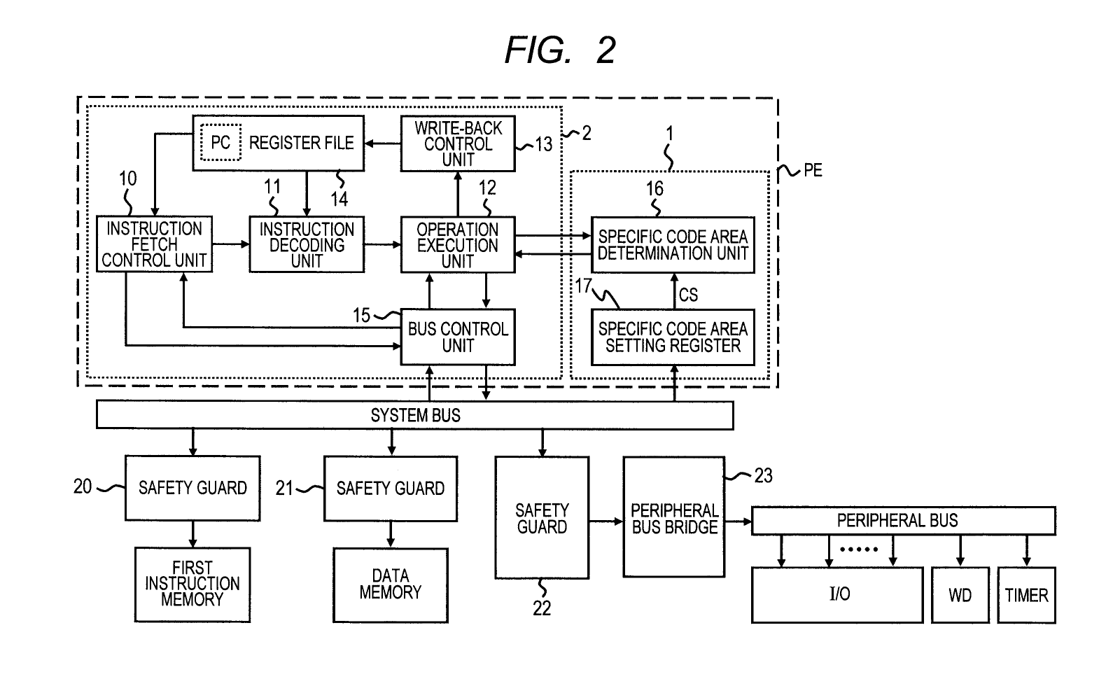

FIG. 2 is a block diagram showing the processor system as the first embodiment of the present invention. As shown in FIG. 2, the processor system as the first embodiment includes a processor element PE, a system bus, safety guards 20 through 22, a first instruction memory, a data memory, a peripheral bus bridge 23, a peripheral bus, an I/O (input/output) device, a WD unit, and a timer. The system bus, first instruction memory, data memory, peripheral bus, WD unit, and timer are the same as their counterparts in the block diagram of FIG. 1 and thus will not be discussed further. The I/O device in FIG. 2 is assumed to include the CAN unit, FLEX RAY unit, SPI unit, UART unit, and ADC unit shown in FIG. 1.

The processor element PE of the first embodiment executes programs including a specific program to output access requests to peripheral devices, while determining simultaneously whether the program being executed by reference to a first set value is the specific program. The first set value corresponds to the address range of a specific code area in which the specific program is stored. In the first embodiment, the processor element PE is assumed to have a specific code area setting register that holds the first set value.

The peripheral devices of the first embodiment have a specific data storage area that stores specific data to be used by the specific program. In the first embodiment, the peripheral devices are assumed to include the first instruction memory, data memory, I/O device, WD unit, and timer.

If an access request results from the execution of the specific program, the safety guards 20 through 22 of the first embodiment permit access to the specific data storage area; if the access request does not result from the execution of the specific program, the safety guards invalidate access to the specific data storage area. In the example of FIG. 2, the safety guard 20 is provided for the first instruction memory, the safety guard 21 for the data memory, and the safety guard 22 for the peripheral devices coupled to the peripheral bus. Also in the example of FIG. 2, the peripheral bus and system bus are coupled with each other via the peripheral bus bridge 23, and the safety guard 22 is placed interposingly between the peripheral bus bridge 23 and the system bus. The peripheral bus bridge 23 performs arbitration of the access requests to the peripheral devices coupled to the peripheral bus.

What follows is a more detailed explanation of the processor element PE and the safety guards 20 through 22.

The processor element PE has a code determination unit 1 and an operation unit 2. The operation unit 2 is an operating core that executes programs. The code determination unit 1 references the first set value to determine whether a program count value generated based on the code of the program being executed by the operation unit 2 belongs to the specific program. If it is determined that the program being executed by the operation unit 2 is the specific program, the code determination unit 1 outputs to the operation unit 2 an instruction to enable a specific code area identification signal output from the processor element PE.

As shown in FIG. 2, the operation unit 2 has an instruction fetch control unit 10, an instruction decoding unit 11, an operation execution unit 12, a write-back control unit 13, a register file 14, and a bus control unit 15. In the example of FIG. 2, the register file 14 stores a program count value PC updated by operation of the operation execution unit 12.

The instruction fetch control unit 10 generates a fetch address by referencing the program count value PC stored in the register file 14. With the fetch address generated, the instruction fetch control unit 10 accesses the first instruction memory via the bus control unit 15. The instruction fetch control unit 10 thus fetches the program code from the area corresponding to the fetch address in the first instruction memory. The instruction fetch control unit 10 issues the fetched instruction to the instruction decoding unit 11. In the description that follows, the fetched instruction will be referred to as the instruction information.

The instruction decoding unit 11 generates an operation instruction by decoding the instruction information issued by the instruction fetch control unit 10. In conjunction with decoding of the operation instruction, the instruction decoding unit 11 generates a program count value PC for the operation instruction in question. The instruction decoding unit 11 then outputs the operation instruction and the program count value PC corresponding to this instruction to the operation execution unit 12. If the register file 14 has any data to be used by the output operation instruction, the instruction decoding unit 11 outputs the data in question to the operation execution unit 12. Alternatively, the instruction decoding unit 11 may output a register address pointing to that location in the register file 14 at which there exists the data to be used by the operation instruction output to the operation execution unit 12.

The operation execution unit 12 performs operations based on the operation instruction output from the instruction decoding unit 11. Also, the operation execution unit 12 outputs to the code determination unit 1 the program count value PC corresponding to the currently executed operation instruction.

The write-back control unit 13 writes the result of the execution by the operation execution unit 12 to the register file 14. At this point, the write-back control unit 13 writes the program count value PC generated anew through processing by the operation execution unit 13 to the register file 14 together with the result of the execution. The register file 14 stores data representative of the result of the processing by the operation execution unit 12 as well as the program count value PC generated by the operation execution unit 12.

Based on the instructions from the operation execution unit 12, the bus control unit 15 sends and receives data to and from the peripheral devices via the system bus. For example, if the operation instruction processed by the operation execution unit 12 is a read instruction, the bus control unit 15 outputs the read instruction as an access request RQ together with an access address ADD pointing to the location of the data to be read. Upon receipt of the read data output by a peripheral device in response to the access request, the bus control unit 15 hands the read data over to the operation execution unit 12. Also, if the operation instruction processed by the operation execution unit 12 is a write instruction, the bus control unit 15 outputs the write instruction as the access request RQ, the data targeted to be written, and the address request ADD pointing to the location to which to write the target data. Further, based on the instructions from the operation execution unit 12, the bus control unit 15 either enables or disables a specific code area identification signal CID that is output along with the access request RQ.

The code determination unit 1 has a specific code area determination unit 16 and a specific code area setting register 17. The specific code area determination unit 16 receives from the operation execution unit 12 a program count value PC regarding the currently executed operation instruction, and determines whether the program count value PC falls within a specific program count range value SC indicated by the first set value. If the program count value PC falls within the specific program count range value, the specific code area determination unit 16 determines that the operation instruction being executed by the operation execution unit 12 beings to the specific program. In that case, the specific code area determination unit 16 instructs the operation execution unit 12 to enable the specific code area identification signal CID. On the other hand, if the program count value PC does not fall within the specific program count range value, then the specific code area determination unit 16 determines that the operation instruction currently executed by the operation execution unit 12 belongs to a program other than the specific program. In this case, the specific code area determination unit 16 instructs the operation execution unit 12 to disable the specific code area identification signal CID.

The specific code area setting register 17 holds the first set value. The first set value corresponds to the address range of the specific code area in which the specific program is stored. With the first embodiment, the first set value is established to represent the range of the program count value PC corresponding to the address range of the specific code area, so as to determine whether the operation instruction being executed by the operation execution unit 12 beings to the specific program. The specific code area setting register 17 outputs the specific program count range value SC as a value indicative of the range of the program count value PC corresponding to the specific program. Because the first set value points to the address range in the first embodiment, the specific code area setting register 17 has a first register for storing a high-order address of the address range and a second register for storing a low-order thereof. The specific code area setting register 17 may be located in an area different from those of the processor element PE.

In the processor system as the first embodiment, the first set value is stored into the specific code area setting register 17 while initial values are being set after the processor element PE is reset.

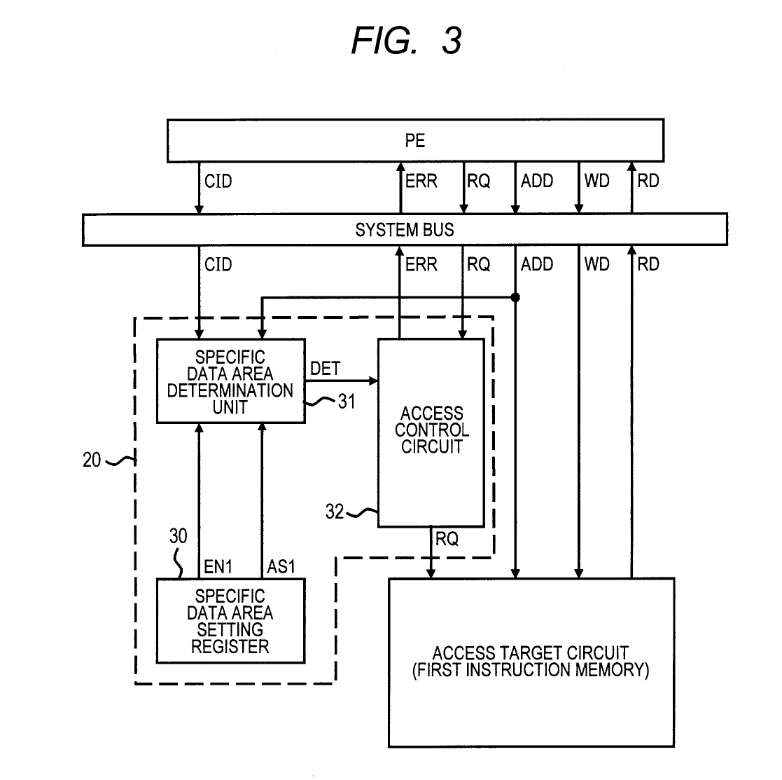

What follows is a detailed explanation of the safety guards 20 through 22. Because the safety guards 20 through 22 are configured identically, the safety guard 20 will be explained as the representative example. FIG. 3 is a block diagram of the safety guard 20. In FIG. 3, the first instruction memory is shown as an access target circuit to be protected by the safety guard 20. As indicated in FIG. 3, the safety guard 20 has a specific data area setting register 30, a specific data area determination unit 31, and an access control circuit 32.

The specific data area setting register 30 stores a second set value. The second set value defines the address range of the specific data storage area that stores the specific data to be used by the specific program. The specific data area setting register 30 outputs the address range indicated by the second set value as a specific data area signal AS1. Also, if the second set value has yet to be stored (e.g., after the processor system has been reset), the specific data area setting register 30 disables an enable signal EN1. The specific data area setting register 30 enables the enable signal EN1 after the second set value is stored. The specific data area setting register 30 may be configured as part of the access target circuit.

The specific data area determination unit 31 is a block that is made effective when the enable signal EN1 is being enabled. The specific data area determination unit 31 receives a specific code area identification signal CID output from the processor element PE along with an access request RQ. When the specific code area identification signal CID is being enabled and when the access address ADD with regard to the access target circuit falls within the address range indicated by the specific data area signal AS1, the specific data area determination unit 31 enables a detection signal DET. When the specific code area identification signal CID is being enabled and when the access address ADD does not fall within the address range indicated by the specific data area signal AS1, the specific data area determination unit 31 disables the detection signal DET. When the enable signal EN1 is being disabled and when the access address ADD does not fall within the address range indicated by the specific data area signal AS1, the specific data area determination unit 31 enables the detection signal DET. When the enable signal EN1 is being disabled, the specific data area determination unit 31 disables the detection signal DET.

When the detection signal DET is being enabled, the access control circuit 32 transmits the access request RQ to the access target circuit. When the detection signal DET is being disabled, the access control circuit 32 outputs an error response signal ERR regarding the access request and invalidates that access request. That is, when the detection signal DET is being disabled, the access control circuit 32 cuts off access from the processor element PE to the access target circuit by invalidating the access request RQ with regard to the access target circuit.

As explained above, each of the safety guards 20 through 22 has the specific data area setting register 30 that stores the second set value defining the address range of the specific data storage area. The safety guards 20 through 22 each compare the second set value with the access address ADD output from the processor element PE along with the access request RQ, so as to determine whether the access request RQ is requesting access to the specific data storage area. Also, each of the safety guards 20 through 22 determines whether the access request RQ results from the execution of the specific program depending on whether the specific code area identification CID is enabled. If it is determined that the access request RQ is given requesting access to the specific data area based on the result of the execution of the specific program, the safety guards 20 through 22 each give the access request RQ to the access target circuit. If it is determined that the access request RQ is given requesting access to the specific data area based on the result of the execution of a program other than the specific program, the safety guards 20 through 22 each invalidate the access request RQ in question to protect the specific data stored in the specific data area. If it is determined that the access request RQ is given requesting access to a data area other than the specific data area based on the result of the execution of a program other than the specific program, the safety guards 20 through 22 each give the access request RQ to the access target circuit.

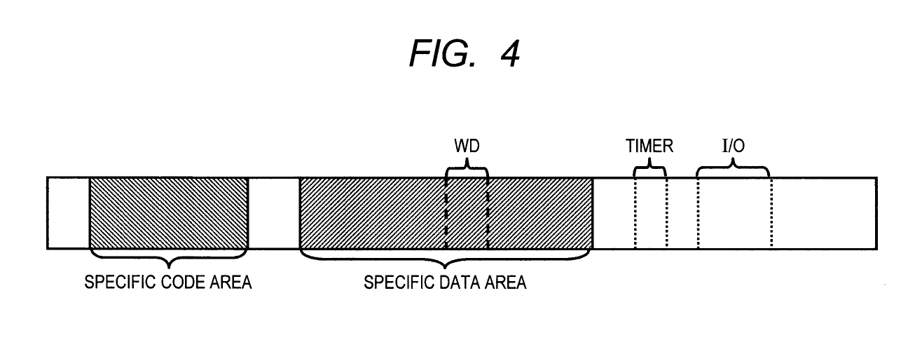

As explained above, the processor system as the first embodiment controls whether or not to permit access to the specific data area depending on whether the program that issued the access request RQ is stored in the specific code area. What follows is a detailed explanation of the specific data area and specific code area. FIG. 4 is a schematic view of a memory space map showing the specific code area and specific data area of the processor system as the first embodiment.

As shown in FIG. 4, the processor system as the first embodiment employs the concept of the memory space map in managing those areas in peripheral devices in which programs and data are stored.

In the memory space map of the processor system as the first embodiment, the specific code area is defined in the address range corresponding to the specific program count range value established as the first set value. The specific code area stores the specific code that belongs to the specific program. The specific program is a secure program that underwent detailed operation verification. For example, the program having undergone detailed operation verification may be a program rid of its defects following verification of its operation on the register level. In another example, the specific program may be a program designed to detect errors of its operation.

Also, in the memory space map of the processor system as the first embodiment, the specific data area is defined in the address range established as the second set value. The specific data is data to be accessed by the specific program. The specific data may include set values of the WD unit in addition to the data for use by the specific program in its operation. If the processor element PE enters a runaway state, the program execution time involved is prolonged. Thus the runaway of the processor element PE can be detected by the WD unit measuring the program execution time. In such a case, the set values of the WD unit may be included in the specific data. This makes it possible to protect the set values of the WD unit against unintended updating if the processor element PE enters a runaway state, whereby the reliability of the processor system is improved.

As explained above, the processor system as the first embodiment determines whether the program executed by the processor element PE is the specific program stored in the specific code area. The safety guard controls whether or not to permit access to the specific data area depending on whether the access request RQ issued by the processor element PE results from the execution of the specific program. In this manner, the processor system as the first embodiment prevents any program other than the specific program from accessing the specific data, whereby the reliability of the processor system is improved.

In some processor systems of the related art, access to specific data is controlled based on access authority. There are cases, however, where an unsecured program having undergone insufficient verification may be unintentionally given authority for access to the specific data. This can lead to poor reliability of the processor system. With the processor system as the first embodiment, by contrast, the specific program can be stored in the specific code area defined by the address range established as the first set value by the user. Because the programs can be configured as described above, the processor system as the first embodiment reliably prevents an unsecured program located in an address range other than the specific code area from accessing the specific data, so that the reliability of the processor system is enhanced.

### Second Embodiment

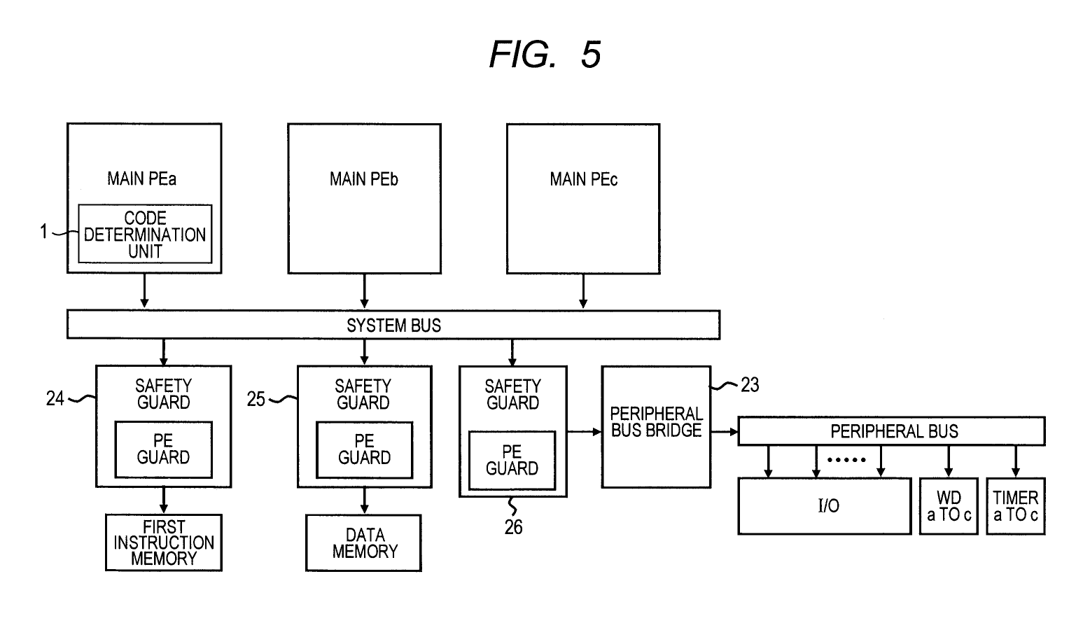

Explained below as the second embodiment is a processor system which has multiple processor elements PE and to which the arrangements of the present invention are applied. FIG. 5 is a block diagram showing a processor system as the second embodiment. In describing the second embodiment, the components that are substantially the same as those already discussed in connection with the first embodiment will be designated by the same reference numerals and their explanations will be omitted where redundant. In the block diagram of the processor system in FIG. 5, each processor element is shown equipped individually with a WD unit and a timer.

As shown in FIG. 5, the processor system as the second embodiment has processor elements PEa through PEc. Only the processor element PEa has the code determination unit 1. That is, the processor element PEa in the second embodiment has the same configuration as that of the processor element PE in the first embodiment. On the other hand, the processor elements PEb and PEc in the second embodiment do not have the code determination unit 1 each, so that they cannot access the specific data. It is assumed that the processor elements PEa through PEc each output a processor element identification signal PEID identifying the self processor element along with the access request RQ.

Also as shown in FIG. 5, the processor system as the second embodiment has safety guards 24 through 26 in place of the safety guards 20 through 22. The safety guards 24 through 26 are configured as the safety guards 20 through 22 each supplemented with a processor element guard (called the PE guard hereunder). The PE guard includes a PE unique area setting register that stores a third set value defining for each processor element the address range of the data storage area that can be accessed by the processor element in question. By reference to the third set value and the processor element identification signal PEID, the safety guard invalidates the access request from any other processor element with regard to the address range that can be accessed only by a given processor element.

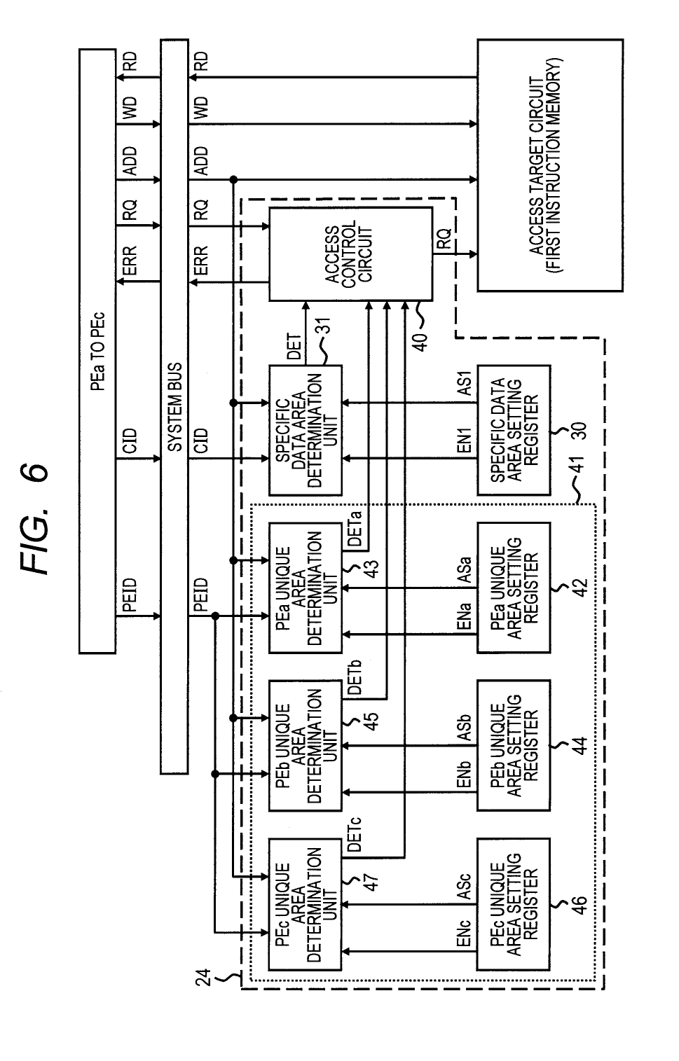

What follows is a detailed explanation of how the safety guards 24 through 26 are each configured. Because the safety guards 24 through 26 are configured identically, the safety guard 24 will be explained as the representative example. FIG. 6 is a block diagram showing the safety guard 24 of the processor system as the second embodiment.

As shown in FIG. 6, the safety guard 24 has an access control circuit 40 in place of the access control circuit 32. The access control circuit 40 is configured as the access control circuit 32 supplemented with the function of performing access control by taking into account the status of detection signals DETa through DETc output from a PE guard 41.

The safety guard 24 includes the PE guard 41. The PE guard 41 has a PEa unique area setting register 42, a PEa unique area determination unit 43, a PEb unique area setting register 44, a PEb unique area determination unit 45, a PEc unique area setting register 46, and a PEc unique area determination unit 47. In the example of FIG. 6, the PEa unique area setting register 42, PEb unique area setting register 44, and PEc unique area setting register 46 are shown located in unique areas. Alternatively, these registers may be configured to be incorporated in the access target circuit.

The PEa unique area setting register 42 stores the third set value (called the PEa unique area set value hereunder) defining the address range of the data storage area that can be accessed by the processor element PEa. The PEa unique area setting register 42 outputs the address range indicated by the PEa unique area set value as a PEa unique area signal ASa. Also, when the PEa unique area set value has yet to be stored (e.g., after the processor system has been reset), the PEa unique area setting register 42 disables an enable signal ENa. After the PEa unique area set value is stored, the PEa unique area setting register 42 enables the enable signal ENa.

The PEa unique area determination unit 43 is a block that is made effective when the enable signal ENa is being enabled. The PEa unique area determination unit 43 receives the processor element identification signal PEID output from the processor element along with an access request RQ. When the processor element identification signal PEID identifies the processor element PEa and when the access address ADD regarding the access target circuit falls within the address range indicated by the PEa unique area signal ASa, the PEa unique area determination unit 43 enables the detection signal DETa. When the processor element identification signal PEID identifies a processor element other than the processor element PEa and when the access address ADD does not fall within the address range indicated by the PEa unique area signal ASa, the PEa unique area determination unit 43 disables the detection signal DETa. When the enable signal ENa is being disabled, the PEa unique area determination unit 43 disables the detection signal DETa.

The PEb unique area setting register 44 stores the third set value (called the PEb unique area set value hereunder) defining the address range of the data storage area that can be accessed by the processor element PEb. The PEb unique area setting register 44 outputs the address range indicated by the PEb unique area set value as a PEb unique area signal ASb. Also, when the PEb unique area set value has yet to be stored (e.g., after the processor system has been reset), the PEb unique area setting register 44 disables an enable signal ENb. After the PEb unique area set value is stored, the PEb unique area setting register 44 enables the enable signal ENb.

The PEb unique area determination unit 45 is a block that is made effective when the enable signal ENb is being enabled. The PEb unique area determination unit 45 receives the processor element identification signal PEID output from the processor element along with an access request RQ. When the processor element identification signal PEID identifies the processor element PEb and when the access address ADD regarding the access target circuit falls within the address range indicated by the PEb unique area signal ASb, the PEb unique area determination unit 45 enables the detection signal DETb. When the processor element identification signal PEID identifies a processor element other than the processor element PEb and when the access address ADD does not fall within the address range indicated by the PEb unique area signal ASb, the PEb unique area determination unit 45 disables the detection signal DETb. When the enable signal ENb is being disabled, the PEb unique area determination unit 45 disables the detection signal DETb.

The PEc unique area setting register 46 stores the third set value (called the PEc unique area set value hereunder) defining the address range of the data storage area that can be accessed by the processor element PEc. The PEc unique area setting register 46 outputs the address range indicated by the PEc unique area set value as a PEc unique area signal ASc. Also, when the PEc unique area set value has yet to be stored (e.g., after the processor system has been reset), the PEc unique area setting register 46 disables an enable signal ENc. After the PEc unique area set value is stored, the PEc unique area setting register 46 enables the enable signal ENc.

The PEc unique area determination unit 47 is a block that is made effective when the enable signal ENc is being enabled. The PEc unique area determination unit 47 receives the processor element identification signal PEID output from the processor element along with an access request RQ. When the processor element identification signal PEID identifies the processor element PEc and when the access address ADD regarding the access target circuit falls within the address range indicated by the PEc unique area signal ASc, the PEc unique area determination unit 47 enables the detection signal DETc. When the processor element identification signal PEID identifies a processor element other than the processor element PEc and when the access address ADD does not fall within the address range indicated by the PEc unique area signal ASc, the PEc unique area determination unit 47 disables the detection signal DETc. When the enable signal ENc is being disabled, the PEc unique area determination unit 47 disables the detection signal DETc.

In the processor system as the second embodiment, only the processor element PEa is allowed to access the specific data area. Thus the access control circuit 40 of the second embodiment permits access to the specific data when the detection signal DET is being enabled and so is the detection signal DETa. When the detection signal DET is being enabled and the detection signal DETa is being disabled, the access control circuit 40 permits access to the PEa unique area except for the specific data. When the detection signal DETb is being disabled, the access control circuit 40 permits access to the PEb unique area. When the detection signal DETc is being disabled, the access control circuit 40 permits access to the PEc unique area.

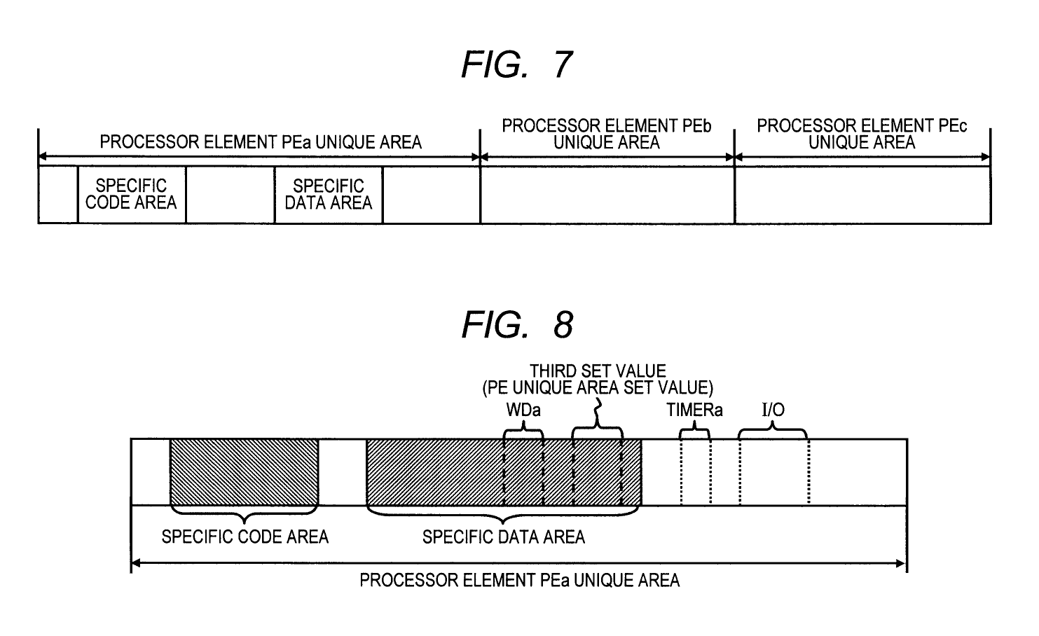

The access control circuit 40 performs access control as explained above because the processor system as the second embodiment establishes the address space map such as one shown in FIG. 7 using the third set value. As indicated in FIG. 7, the processor system as the second embodiment has the specific code area and specific data area located in an area unique to the processor element PEa. Also, the area unique to the processor element PEa, an area unique to the processor element PEb, and an area unique to the processor element PEc are arranged not to overlap with one another.

What follows is an explanation of the processor element PEa unique area, processor element PEb unique area, and processor element PEc unique area of the processor system as the second embodiment.

FIG. 8 is a schematic view showing a memory space map of the processor element PEa unique area. As shown in FIG. 8, the specific code area and specific data area are located in the processor element PEa unique area. The specific data area includes information representative of set values of the WD unit (WDa) and the third set value. The set values of a timer “a” and an I/O device are located in an area other than the specific data area and specific data area of the processor element PEa unique area.

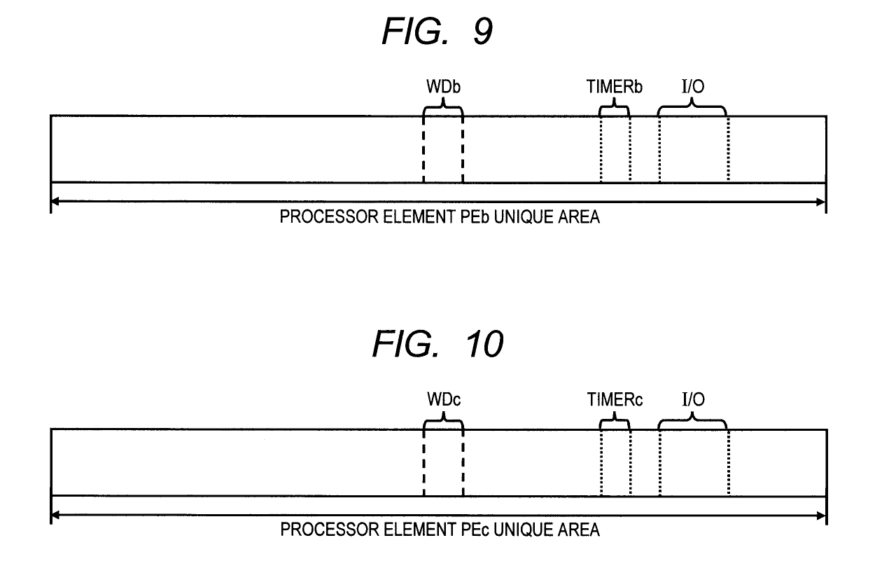

FIG. 9 is a schematic view showing a memory space map of the processor element PEb unique area. As shown in FIG. 9, the specific code area and specific data area are not located in the processor element PEb unique area. The set values of the WD unit (WDb), a timer “b” and an I/O device are located where appropriate in the processor element PEb unique area.

FIG. 10 is a schematic view showing a memory space map of the processor element PEc unique area. As shown in FIG. 10, the specific code area and specific data area are not located in the processor element PEc unique area. The set values of the WD unit (WDc), a timer “c” and an I/O device are located where appropriate in the processor element PEc unique area.

As can be seen from the foregoing explanation, the processor system as the second embodiment has one managing processor element (e.g., processor element PEa) that determines whether the executed program is the specific program in reference to the first set value, leaving the other processor elements acting as ordinary processor elements (e.g., processor element PEb and PEc) that do not perform such determination. In that configuration, the ordinary processor elements are prevented from erroneously accessing the specific data.

Also, the processor system as the second embodiment allows only one managing processor element to access the specific code area and specific data, with the specific data arranged to include the third set value defining the range of the available data area that can be accessed by each processor element. Configured in this manner, the processor system as the second embodiment protects the settings of the PE guard-protected areas (i.e., third set values) from getting altered by ordinary processor elements through malfunction. Furthermore, because the processor system as the second embodiment enables only the program stored in the specific code area to access the specific data area, the managing processor element is prevented from unintentionally altering the settings of the PE guard-protected areas (third set values). The processor system as the second embodiment thus prevents the third set values from getting altered by both the managing processor element and the ordinary processor elements through malfunction, whereby the reliability of the processor system is boosted.

### Third Embodiment

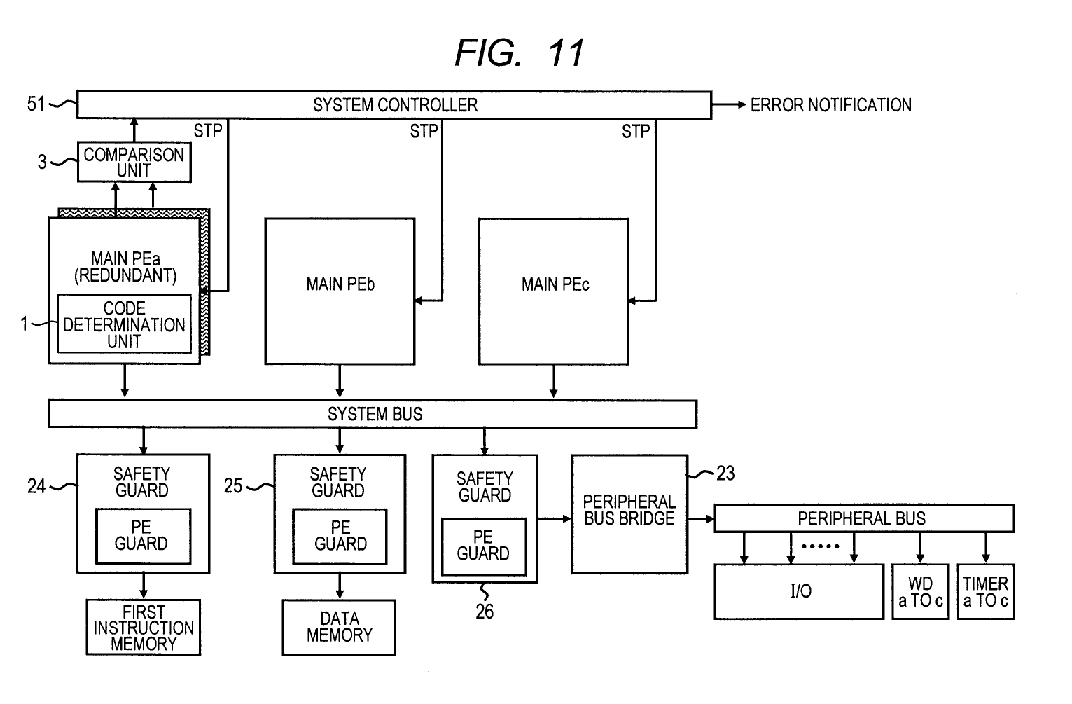

The third embodiment of the present invention is a modification of the processor system as the second embodiment. FIG. 11 is a block diagram showing a processor system as the third embodiment. In describing the third embodiment, the components that are substantially the same as those already discussed in connection with the first and the second embodiments will be designated by the same reference numerals and their explanations will be omitted where redundant.

As shown in FIG. 11, the processor system as the third embodiment is configured so that the processor element PEa can operate redundantly. Operating redundantly means that in software terms, the processor element PEa works as a single processor element and that in hardware terms, the processor element PEa is configured in multiplexed fashion or supplemented with check circuits or the like so as to operate reliably. The processor system as the third embodiment has a comparison unit 3 that compares the results from two operations involving a redundant operation. If the comparison results in a mismatch, the comparison unit 3 outputs an error signal. That is, the processor system as the third embodiment is configured to have an error detection feature that detects errors in the executed program.

Furthermore, the processor system as the third embodiment has a system controller 51 that stops the managing processor element (e.g., processor element PEa) if an error is detected therein. In the example of FIG. 11, when the comparison unit 3 outputs an error signal, the system controller 51 enables a stop signal STP that is output to the processor elements PEa through PEc. Given the stop signal STP being enabled, the processor elements PEa through PEc stop their operations. The system controller 51 is also configured to notify an entity outside the processor system of the errors that have occurred inside.

As explained above, if the managing processor element develops irregularities such as malfunction or program alteration, the processor system as the third embodiment can detect the event as an error and stop the processor system operation. With the processor system stopped upon occurrence of an error, it is possible to minimize the damage stemming from the error.

### Fourth Embodiment

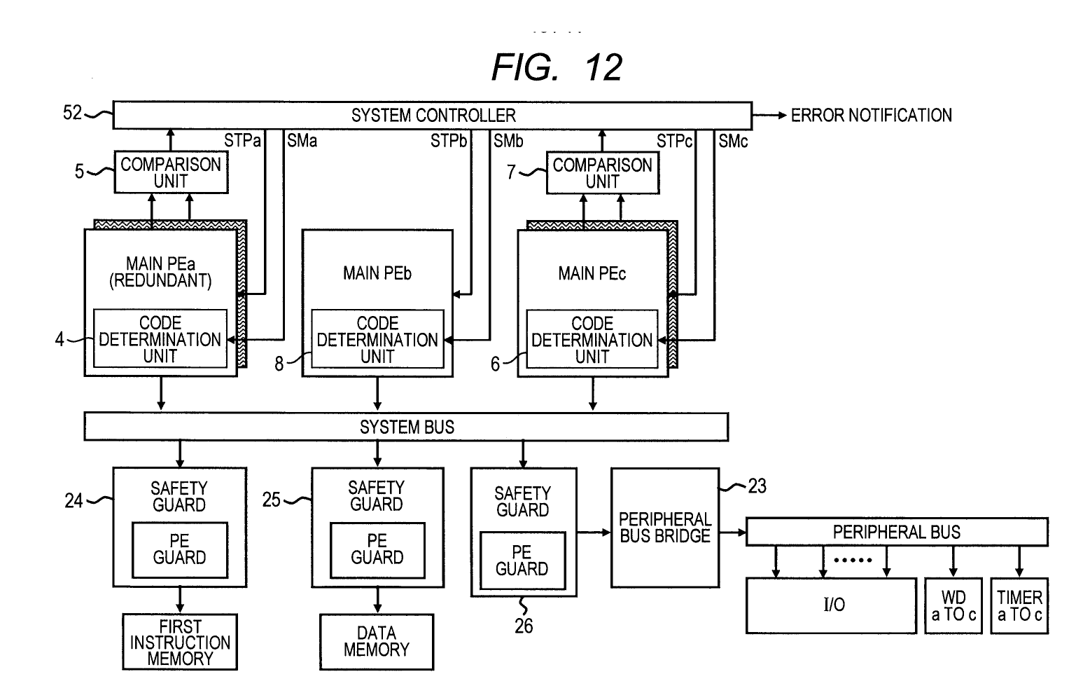

The fourth embodiment of the present invention is a modification of the processor system as the third embodiment. FIG. 12 is a block diagram showing a processor system as the fourth embodiment. In describing the fourth embodiment, the components that are substantially the same as those already discussed in connection with the first through the third embodiments will be designated by the same reference numerals and their explanations will be omitted where redundant.

The processor system as the fourth embodiment has one of multiple processor elements configured as the managing processor element. If the managing processor element develops malfunction, the processor system causes another processor element to be configured as the new managing processor element. This operation is accomplished by the fourth embodiment using a system controller 52 in place of the system controller 51.

As shown in FIG. 12, the processor system as the fourth embodiment has the processor elements PEa through PEc equipped with code determination units 4, 6 and 8, respectively. The processor elements PEa and PEc are configured to be capable of redundant operations. Comparison unit 5 and 7 are further provided corresponding to the processor elements PEa and PEc, respectively. The comparison units 5 and 7 each compare the results of two operations involving a redundant operation, and output an error signal if the comparison results in a mismatch. That is, the processor system as the fourth embodiment is configured to have an error detection feature that detects errors in the executed program.

Whereas the code determination units 4, 6 and 8 operate in substantially the same manner as the code determination unit 1 of the first embodiment, whether the operation is enabled or disabled is controlled using safe mode signals SMa through SMc output from the system controller 52.

The system controller 52 outputs the safe mode signals SMa through SMc and stop signals STPa through STPc. At this time, the system controller 52 enables one of the safe mode signals SMa through SMc. If the processor element supplied with the enabled safe mode signal outputs an error signal, the system controller 52 enables the stop signal destined for the processor element having signaled the error so as to stop that processor element. Thereafter, the system controller 52 enables one of the safe mode signals output to the processor elements other than the stopped processor element. In this manner, if the processor element acting as the managing processor element develops malfunction, the processor system establishes another processor element as the newly configured managing processor element.

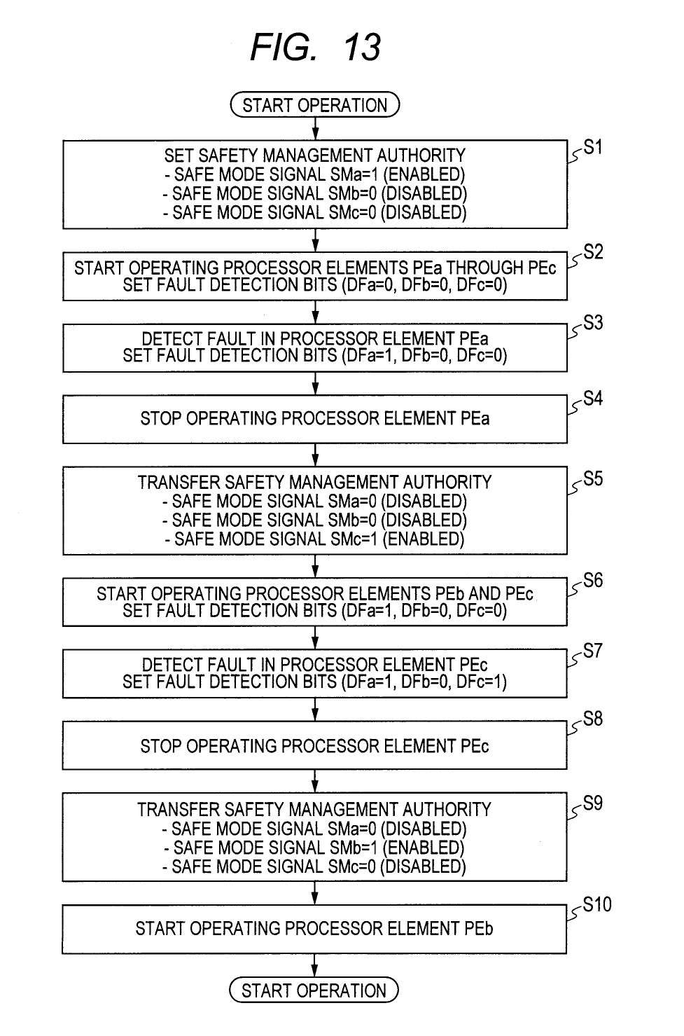

What follows is a more detailed explanation of a typical operation of the system controller 52. FIG. 13 is a flowchart showing how the system controller 52 typically operates. As shown in FIG. 13, when the processor system as the fourth embodiment is started, the system controller 52 enables the safe mode signal SMa (e.g., puts it into a “1” state) and disables the safe mode signals SMb and SMc (e.g., puts them into a “0” state each)(in step S1). In the processor system as the fourth embodiment, these settings cause the processor element PEa to operate as the managing processor element and the processor elements PEb and PEc to act as ordinary processor elements (in step S2).

If an error is detected in the processor element PEa, the system controller 52 sets a fault detection bit DFa to “1” and fault detection bits DFb and DFc to “0” each inside the block, enables the stop signal STPa destined for the processor element PEa, and disables the stop signals STPb and STPc (in step S3). The settings cause the processor element PEa to stop its operation (in step S4).

The system controller 52 proceeds to enable the safe mode signal SMb and disable the safe mode signals SMa and SMc (in step S5). In the processor system as the fourth embodiment, these settings cause the processor element PEc to operate as the managing processor element and the processor element PEb to act as an ordinary processor element (in step S6).

Then if an error is detected in the processor element PEc, the system controller 52 sets the fault detection bits DFa and DFc to “1” each and the fault detection bit DFb to “0” inside the block, enables the stop signal STPc destined for the processor element PEc, and disables the stop signal STPc (in step S7). The settings cause the processor element PEc to stop its operation (in step S8).

The system controller 52 proceeds to enable the safe mode signal SMc and disable the safe mode signals SMa and SMb (in step S9). In the processor system as the fourth embodiment, these settings cause the processor element PEb to operate as the managing processor element (in step S10).

If there is only one operable processor element left as discussed above, it is preferred that only the processes during which the entire system incorporating the processor system functions normally be carried out and that the system as a whole be stopped upon completion of these processes. The processor elements with no error detection feature are less reliable in performance. If any such processor element is left to continue its processing, the reliability of the entire system can be jeopardized.

Although not explained in the flowchart of FIG. 13, where another processor element is selected as the newly configured managing processor element, it is preferred that the processor system be reset to reestablish the set values for operating the code determination units, safety guards, and PE guard. That is because the address range of the specific code area to be determined by the code determination units and the specific data area to be protected by the safety guards are located in those areas unique to the processor elements which are utilized by the managing processor element before the change; these settings need to be changed in keeping with the newly configured managing processor element.

As explained above, if an error occurs in the managing processor element, the processor system as the fourth embodiment replaces the faulty managing processor element with the newly configured managing processor element. This makes it possible to let the processor system operate continuously even if the processor element configured to act as the managing processor element has become faulty.

If the processor system as the fourth embodiment has multiple error-detecting processor elements (called high-reliability processor elements), one of the high-reliability processor elements is selected preferentially as the newly configured managing processor element. This makes it possible for the processor system to operate continuously while maintaining its reliability.

It should be understood that the present invention when embodied is not limited to the above-described embodiments and that various modifications, variations and alternatives may be made of the invention so far as they are within the scope of the appended claims or the equivalents thereof. For example, although when and how to set the first through the third set values mentioned above was not explained in detail in the foregoing paragraphs, these set values should preferably be set during initialization following the reset operation of the processor system. The third set value for the PE guard should preferably be configured to be altered by the managing processor element. This will allow the memory space map of the processor system to be changed flexibly, which in turn will enhance the flexibility of the processor system configuration.

What is claimed is:

1. A processor system comprising:
a specific code area setting register configured to hold a first set value corresponding to an address range of a specific code area in which a specific program is stored;
a peripheral device configured to include a specific data storage area for storing specific data to be used by the specific program;
a processor element configured to output an access request to the peripheral device upon executing programs including the specific program, and to determine whether the program executed by reference to the first set value is the specific program, and
a safety guard configured such that if the access request results from the execution of the specific program, the safety guard permits access to the specific data storage area and that if the access request results from the execution of a program other than the specific program, then the safety guard invalidates access to the specific data storage area.

2. The processor system according to claim 1, wherein the safety guard includes a specific data area setting register configured to store a second set value defining an address range of the specific data storage area, and
wherein the safety guard compares an access address output from the processor element together with the access request, with the second set value to determine whether the access request is requesting access to the specific data storage area.

3. The processor system according to claim 1, wherein the processor element outputs a specific code area identification signal that is enabled if the executed program is the specific program, and
wherein the safety guard determines whether the access request results from the execution of the specific program depending on whether the specific code area identification signal is enabled.

4. The processor system according to claim 3, wherein the processor elements generates a program count value indicative of an address of the specific code area in which the executed program is stored;
wherein the specific code area setting register holds as the first set value a specific program count range value indicative of the address range corresponding to the specific code area in which the specific program is stored, and
wherein the processor element includes a specific code determination unit configured to enable the specific code area identification signal if the program count value falls within the specific program count range value.

5. The processor system according to claim 1, wherein the peripheral device includes a watchdog timer configured to manage an execution time of each of the programs executed by the processor element, and
wherein the specific data includes set values of the watchdog timer.

6. The processor system according to claim 1, further comprising a plurality of processor elements;
wherein one of the processor elements functions as a managing processor element to determine whether the program executed by reference to the first set value is the specific program, and
wherein the remaining processor elements function as ordinary processors not determining whether the program executed by reference to the first set value is the specific program.

7. The processor system according to claim 6, wherein the processor elements each output, along with the access request, a processor element identification signal identifying the self processor element;
wherein the safety guard includes a specific data area setting register configured to store a third set value defining an address range of a data storage area allowed to be accessed by each of the processor elements, and references the third set value and the processor element identification signal to invalidate the access request for the address range allowed to be accessed by any one processor element if the access request comes from any other processor element.

8. The processor system according to claim 7, wherein the third set value is placed in the specific data storage area, and
wherein the specific program operating on the third set value and the specific data storage area are placed in a data storage area of which an address range is not allowed to be accessed by the ordinary processors.

9. The processor element according to claim 6, wherein the managing processor element includes an error detection feature configured to detect an error in the executed program.

10. The processor system according to claim 6, further comprising a system controller configured to stop the operation of the processor elements if an error is detected in the managing processor element.

11. The processor system according to claim 6, further comprising a system controller configured such that if an error is detected in the managing processor element, the system controller stops the managing processor element and selects one of the ordinary processor elements as the managing processor element.
